(19) United States
(12) Patent Application Publication
(10) Pub. No.: US 2026/0186860 A1
(43) Pub. Date: Jul. 2, 2026

(54) Generating Auto-Scaling Configurations for Graphics Processing Unit (GPU) Models

(71) Applicant: eBay Inc., San Jose, CA (US)

(72) Inventors: Tianyu Chen, Jiuquan (CN); Jingjing Jiang, Shanghai (CN); Xin Li, Shanghai (CN); Tianming Lu, Shanghai (CN); Vinay Phegade, Santa Clara, CA (US); Yiheng Wang, Shanghai (CN); Zhongyuan Wu, Shanghai (CN); Guansheng Zhu, Shanghai (CN)

(73) Assignee: eBay Inc., San Jose, CA (US)

(21) Appl. No.: 19/005,603

(22) Filed: Dec. 30, 2024

(51) Int. Cl. G06F 9/50; G06F 9/445; G06Q 30/0601

(52) U.S. Cl. CPC G06F 9/5083; G06F 9/44505; G06Q 30/0641

(57) ABSTRACT

A system for automatically generating auto-scaling configurations for graphics processing unit (GPU) models is described. A provides users a platform to perform a load and performance (LnP) test on a model of a GPU of a computing device. The LnP test may result in a set of metrics associated with the GPU model. For example, the metrics may include throughput metrics (e.g., transactions per second (TPS)) and GPU utilization metrics. In some examples, the metrics may be based on a service level agreement (SLA), which may include latency, error rate, and GPU utilization requirements. Based on a scaling threshold determined from the metrics and a utilization requirement, the system may output an auto-scaling configuration for the GPU model. The GPU may operate using the auto-scaling configuration, where the auto-scaling configuration may enable the GPU model to scale up or scale down, for example, based on changes in traffic.

### BACKGROUND

Online marketplaces support and thus experience numerous and varied activities that facilitate transactions on the online marketplace. Some such activities may be automatically identified as safe or as fraudulent based on a set of deterministic rules, where safe activities may be approved and fraudulent activities may be rejected. If an activity does not satisfy a deterministic rule, a customer support agent may be tasked with reviewing the activity to determine whether it is safe to allow or fraudulent and should thus be rejected.

### SUMMARY

Automated auto-scaling for graphics processing units (GPUs) is leveraged for a computing device. In one or more implementations, a computing device may support one or more models of GPUs. A system may receive a request from a computing device to perform a load and performance (LnP) test on a model of a GPU of the computing device. Based on the LnP test, the system may determine a set of metrics for the model, including throughput and utilization metrics. In some implementations, the system may determine a scaling threshold based on the set of metrics, and the system may use the scaling threshold and a resource utilization requirement to output an auto-scaling configuration for the model. The auto-scaling configuration may enable automatic scaling of a quantity of GPUs used for the computing device.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts an example of a scaling threshold diagram for automatically generating auto-scaling configurations for GPU models.

FIG. 3 depicts an example of a user flow for automatically generating auto-scaling configurations for GPU models.

FIG. 4 depicts an example of a test flow for automatically generating auto-scaling configurations for GPU models.

FIG. 5 depicts an example of auto-scaling for automatically generating auto-scaling configurations for GPU models.

FIG. 6 depicts an example of a process flow for automatically generating auto-scaling configurations for GPU models.

FIG. 7 depicts an example of a binary search for automatically generating auto-scaling configurations for GPU models.

FIGS. 8 and 9 depict examples of process flows for automatically generating auto-scaling configurations for GPU models.

FIG. 10 depicts an example of a binary search for automatically generating auto-scaling configurations for GPU models.

FIGS. 11 through 13 depict examples of process flows for automatically generating auto-scaling configurations for GPU models.

FIG. 14 depicts a procedure in an example implementation of system for automatically generating auto-scaling configurations for GPU models.

FIG. 15 illustrates an example of a system that includes an example computing device that is representative of one or more computing systems and/or devices that may implement the various techniques described herein.

### DETAILED DESCRIPTION

### Overview

Techniques for auto-scaling automation for GPUs are described. In accordance with the described techniques, an online marketplace may support and experience numerous and varied activities that facilitate transactions on the online marketplace. Users may access and perform the activities on the online marketplace via a computing device or a remote computing device (e.g., a mobile device, a desktop computer, a laptop computer, etc.). The online marketplace may leverage multiple GPUs to enhance computational performance. For example, multiple GPUs may work in parallel to process data operations and serve traffic on the online marketplace. Distributing the workload across multiple GPUs may improve efficiency and reduce latency, particularly in high-performance computing environments. Each GPU may be dedicated to specific tasks, such as handling image rendering or processing real-time data. Alternatively, GPUs may handle different tasks based on traffic needs. In the context of cloud computing and remote computing environments, GPU models may refer to different types of GPU configurations available for virtual machines or instances, which may allow system administrators to select a GPU that matches specific performance, computational, and resource management needs.

Auto-scaling of GPU models may refer to the dynamic allocation of GPU resources based on real-time demands of the system. For examples, GPU models may be auto-scaled based on traffic associated with the online marketplace. Auto-scaling automatically adjusts a number of active GPUs, specifically by scaling up the number of GPUs operating when a workload increases (e.g., during periods of high computational demand or high traffic) and scaling down the number of GPUs operating when the demand decreases. Scaling down the number of GPUs based on traffic decreasing may improve resource utilization and efficiency.

To perform auto-scaling of different GPU models, a system may monitor performance metrics such as GPU utilization, throughput, memory usage, and other metrics to determine whether to scale up additional GPUs or scale down GPUs that may no longer be needed. By utilizing auto-scaling, systems and applications may more efficiently manage different computational tasks, particularly for large-scale data processing.

Kubernetes Event-Driven Autoscaling (KEDA) is a native metrics-based solution used to automatically scale up or scale down deployment replica (e.g., GPU models) to adapt to ongoing traffic loads the deployment is to handle. Using KEDA, resources may be allocated on-demand instead of pre-allocated based on a peak load, which may result in significant resource savings, especially for expensive resources such as GPUs. KEDA may be used to scale applications based on the occurrence of specific events, rather than based only on traditional metrics such as memory or computer processing unit (CPU) usage. KEDA may be particularly useful in scenarios where external events such as cause workloads to have fluctuating demand, such as incoming HTTP requests as in the case of the online marketplace. When external events are associated with GPU-based workloads, KEDA may be used to scale a number of GPU replicas or otherwise adjust resources allocated to GPU-enabled pods in real-time. For example, as demand increases (e.g., as traffic on the online marketplace increases), KEDA may be used to automatically scale up the amount of resources configured to handle GPU-based tasks, ensuring that the system has sufficient computation resources to handle the increased load. When the demand decreases, KEDA may be used to scale down the amount of resources, freeing the resources for other needs while reducing present computational costs.

KEDA supports a robust list of metric sources to trigger auto-scaling, however, current KEDA-based solutions are configured service-by-service or use case-by-use case, such that there lacks a standard configuration to automatically generate auto-scaling configurations on-demand. Performing auto-scaling using KEDA for a particular GPU requires significant manual efforts to monitor performance metrics and generate corresponding auto-scaling configurations. Specifically, manual efforts are needed to iteratively tune auto-scaling configurations to find an appropriate auto-scaling configuration for a specific GPU deployment, which may take up to several days. This limits the adaptability of auto-scaling. In addition, it may be difficult to support auto-scaling using KEDA while also meeting or guaranteeing service level agreements (SLAs). Specifically, challenges may include data patterns of requests for different use cases changing over time, performance bottlenecks being more likely to occur at a GPU rather than a CPU, performance of different GPU models may vary significantly, the system may support a number of GPU model serving pools with a different SLA for each pool, and a service initialization time may not be ignorable for GPU model serving, where it may be possible to trigger auto-scaling too early or too late when traffic begins to increase.

Thus, to reduce the manual efforts required for current KEDA-based solutions, the described techniques utilize KEDA to automatically generate auto-scaling configurations to manage GPU deployments. To auto-generate auto-scaling configurations in an adaptive manner (e.g., for any GPU model rather than on a case-by-case basis), a system may provide a platform (e.g., a self-service) which allows users to perform LnP testing for their newly-deployed GPU models. For example, when a new GPU model is onboarded, the system may receive a request from a user via a computing device to perform LnP testing on the new GPU model. The LnP testing may result in key metrics and other results associated with the GPU model. The system may collect the metrics from the LnP testing and automatically generate an auto-scaling configuration based on a model or algorithm. In some implementations, the auto-scaling configuration may be automatically generated based on a scaling threshold determined from the metrics and a resource utilization requirement. The GPU model may then be deployed with the auto-scaling configuration. Because the auto-scaling configuration is generated automatically, the described techniques may be scalable to different types of GPU model deployment at a large scale.

In at least some implementations, once the GPU model has been deployed into production, the auto-scaling configuration may be adaptively auto-refreshed (e.g., automatically updated) based on real production cases and scenarios. For example, the system may support and automated process for periodically collect requests from production (e.g., the GPU deployment) and automatically generate LnP test cases without user involvement. The system may apply the LnP testing to the GPU model to obtain metrics associated with the GPU model. Using the metrics, the system may automatically update the auto-scaling configuration or automatically refresh the previously-generated auto-scaling configuration based on the model or algorithm. In at least one variation, the auto-scaling configuration may be validated and automatically deployed for the GPU model in production once validated.

The described techniques may result in improved resource utilization, increased throughput and decreased latency, and improved computational efficiency. For example, by supporting automatic generation of auto-scaling configurations for GPU models, the described techniques may improve resource utilization by more accurately and continuously scaling up and scaling down GPU models based on traffic patterns, rather than scaling GPUs on a case-by-case basis. In addition, the described techniques may improve throughput and latency by continuously updating auto-scaling configurations rather than relying on manual efforts, resulting in much less downtime for GPU models. In addition, because the system provides users a platform for performing LnP testing, making the model for automatically generating auto-scaling configurations transparent to users, the described techniques may significantly reduce users' learning curves of KEDA, and users may rely on the automatic execution of these techniques to manage GPU deployment.

In some aspects, the techniques described herein relate to a computer-implemented method including: receiving, from a computing device, a request to perform a LnP test on a model of a GPU of the computing device; determining at least one set of metrics for the model of the GPU based on the LnP test; outputting an auto-scaling configuration for the model of the GPU based on a scaling threshold associated with the at least one set of metrics and a resource utilization requirement; and causing the GPU to operate using the auto-scaling configuration.

In some aspects, the techniques described herein relate to a computer-implemented method further including receiving an additional request to perform the LnP test of the model of the GPU; performing the LnP test based on the additional request; and outputting an updated auto-scaling configuration based on at least one additional set of metrics determined for the model of the GPU based on the LnP test.

In some aspects, the techniques described herein relate to a computer-implemented method further including receiving, from an additional computing device, an additional request to perform the LnP test for a plurality of models of GPUs; outputting a plurality of auto-scaling configurations based on at least one additional set of metrics determined for the plurality of models of GPUs based on the LnP test; storing the plurality of auto-scaling configurations; and causing the GPUs to operate using the plurality of auto-scaling configurations.

In some aspects, the techniques described herein relate to a computer-implemented method further including applying the auto-scaling configuration to a plurality of models of GPUs.

In some aspects, the techniques described herein for outputting the auto-scaling configuration relate to a computer-implemented method further including determining the scaling threshold based on the at least one set of metrics, including a maximum TPS and a minimum TPS, and wherein the maximum TPS and the minimum TPS are based on an SLA corresponding to the model of the GPU.

In some aspects, the techniques described herein relate to a computer-implemented method, wherein the LnP test is based on at least one of an SLA, a sample payload, and a GPU utilization threshold.

In some aspects, the techniques described herein for determining the at least one set of metrics relate to a computer-implemented method further including determining a startup time associated with the model of the GPU, wherein the startup time is a duration of time between when a scaling up of the model of the GPU begins and when the model of the GPU is ready to serve traffic.

In some aspects, the techniques described herein relate to a computer-implemented method, wherein the auto-scaling configuration includes at least one of a time at which the model of the GPU is to begin scaling up or a time at which the model of the GPU is to begin scaling down based on a maximum TPS and an SLA.

In some aspects, the techniques described herein relate to a computer-implemented method, wherein the auto-scaling configuration is associated with KEDA.

In some aspects, the techniques described herein relate to a computer-implemented method, wherein the auto-scaling configuration enables scaling of a quantity of GPUs used for the computing device based on the at least one set of metrics and the resource utilization requirement.

In some aspects, the techniques described herein relate to a system including: one or more processors; and memory storing instructions that, when executed by the one or more processors, cause the system to: receive, from a computing device, a request to perform a LnP test on a model of a GPU of the computing device; determine at least one set of metrics for the model of the GPU based on the LnP test; output an auto-scaling configuration for the model of the GPU based on a scaling threshold associated with the at least one set of metrics and a resource utilization requirement; and cause the GPU to operate using the auto-scaling configuration.

In some aspects, the techniques described herein relate to a system, wherein the instructions further cause the system to receive an additional request to perform the LnP test of the model of the GPU; perform the LnP test based on the additional request; and output an updated auto-scaling configuration based on at least one additional set of metrics determined for the model of the GPU based on the LnP test.

In some aspects, the techniques described herein relate to a system, wherein the instructions further cause the system to receive, from an additional computing device, an additional request to perform the LnP test for a plurality of models of GPUs; output a plurality of auto-scaling configurations based on at least one additional set of metrics determined for the plurality of models of GPUs based on the LnP test; storing the plurality of auto-scaling configurations; and cause the GPUs to operate using the plurality of auto-scaling configurations.

In some aspects, the techniques described herein relate to a system, wherein the instructions further cause the system to apply the auto-scaling configuration to a plurality of models of GPUs.

In some aspects, the techniques described herein for outputting the auto-scaling configuration relate to a system, wherein the instructions further cause the system to determine the scaling threshold based on the at least one set of metrics, including a maximum TPS and a minimum TPS, and wherein the maximum TPS and the minimum TPS are based on an SLA corresponding to the model of the GPU.

In some aspects, the techniques described herein relate to a system, wherein the LnP test is based on at least one of an SLA, a sample payload, and a GPU utilization threshold.

In some aspects, the techniques described herein for determining the at least one set of metrics relate to a system, wherein the instructions further cause the system to determine a startup time associated with the model of the GPU, wherein the startup time is a duration of time between when a scaling up of the model of the GPU begins and when the model of the GPU is ready to serve traffic.

In some aspects, the techniques described herein relate to a system, wherein the auto-scaling configuration includes at least one of a time at which the model of the GPU is to begin scaling up or a time at which the model of the GPU is to begin scaling down based on a maximum TPS and an SLA.

In some aspects, the techniques described herein relate to a system, wherein the auto-scaling configuration is associated with KEDA.

In some aspects, the techniques described herein relate to a system, wherein the auto-scaling configuration enables scaling of a quantity of GPUs used for the computing device based on the at least one set of metrics and the resource utilization requirement.

In some aspects, the techniques described herein relate to one or more computer-readable storage media that, when executed by one or more processors, cause the one or more processors to perform operations including: receiving, from a computing device, a request to perform a LnP test on a model of a GPU of the computing device; determining at least one set of metrics for the model of the GPU based on the LnP test; outputting an auto-scaling configuration for the model of the GPU based on a scaling threshold associated with the at least one set of metrics and a resource utilization requirement; and causing the GPU to operate using the auto-scaling configuration.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### Example of an Environment

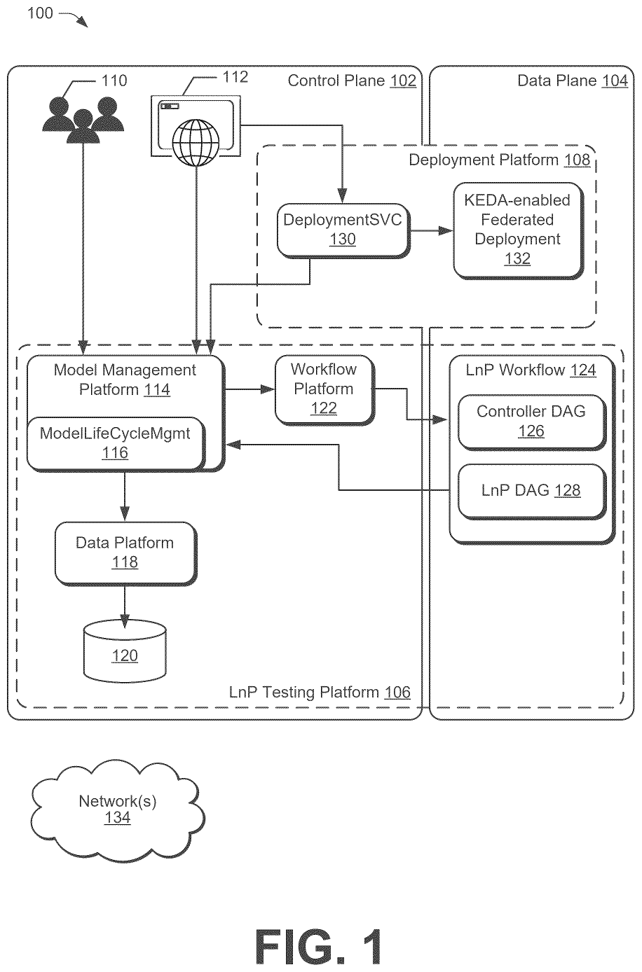

FIG. 1 is an illustration of an environment 100 in an example implementation that is operable to employ techniques described herein. The environment 100 includes a control plane 102 and a data plane 104 that support an LnP testing platform 106 and a deployment platform 108. The LnP testing platform 106 may enable testing of a GPU model, and the deployment platform 108 may enable deployment of the GPU model. The LnP testing platform 106 may include a model management platform 114, a data platform 118, and a workflow platform 122. In one or more implementations, the model management platform 114, the data platform 118, and the workflow platform 122 may be communicatively coupled, one to another, via network(s) 134. One example of the network(s) 134 is the Internet, although one or more of the model management platform 114, the data platform 118, and the workflow platform 122 may be communicatively coupled using one or more different connections or different networks in various implementations (e.g., a cloud).

Although the model management platform 114 is depicted in the environment 100 as being separate from the data platform 118 and the workflow platform 122, in one or more implementations, an entirety or various portions of the model management platform 114 is implemented at or by the data platform 118 and/or the workflow platform 122.

Additionally, the LnP testing platform 106 may include an LnP workflow 124, which may support a controller DAG 126 and an LnP DAG 128 in the data plane 104. The deployment platform 108 may enable a deploymentSVC 130 and a KEDA-enabled federated deployment 132.

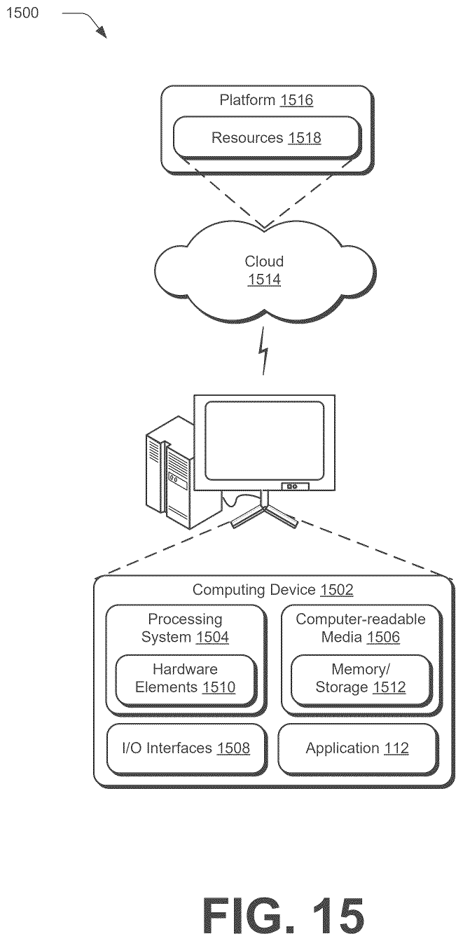

Computing devices, including computing devices, that implement the environment 100 are configurable in a variety of ways. A computing device, for instance, is configurable as a desktop computer, a laptop computer, a mobile device (e.g., assuming a handheld configuration such as a tablet or mobile phone), an Internet-of-Things (IoT) device, a wearable device (e.g., a smart watch, a ring, or smart glasses), an augmented reality (AR)/virtual reality (VR) device (e.g., the smart glasses), a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm utilized to perform operations “over the cloud” as further described in relation to FIG. 15.

The LnP testing platform 106 may support an automated LnP test for one or more GPU models (e.g., supporting traffic for an online marketplace). Based on SLA requirements, including latency and error rate goals, and an LnP payload as an input, the LnP testing platform 106 may run multiple rounds of LnP testing to determine a maximum TPS per replica while meeting SLA requirements (i.e., TPSₘₐₓ) and a minimum TPS per replica (i.e., TPSₘᵢₙ) while meeting GPU utilization requirements (e.g., a GPU utilization goal of 30%).

In at least one implementation, users 110 of a computing device may use an artificial intelligence (AI) hub 112 to manage auto-scaling configurations for one more GPU models. For examples, the users 110 may start an LnP job through the AI hub 112. The AI hub 112 may call ModelLifeCycleMgmt 116 in the model management platform 114 (e.g., MLPManagementSVC) to trigger an automated LnP job. In doing so, the AI hub 112 may provide a self-service platform to the users 110 by which the users may perform LnP testing of a newly onboarded GPU model or a GPU model that is currently deployed.

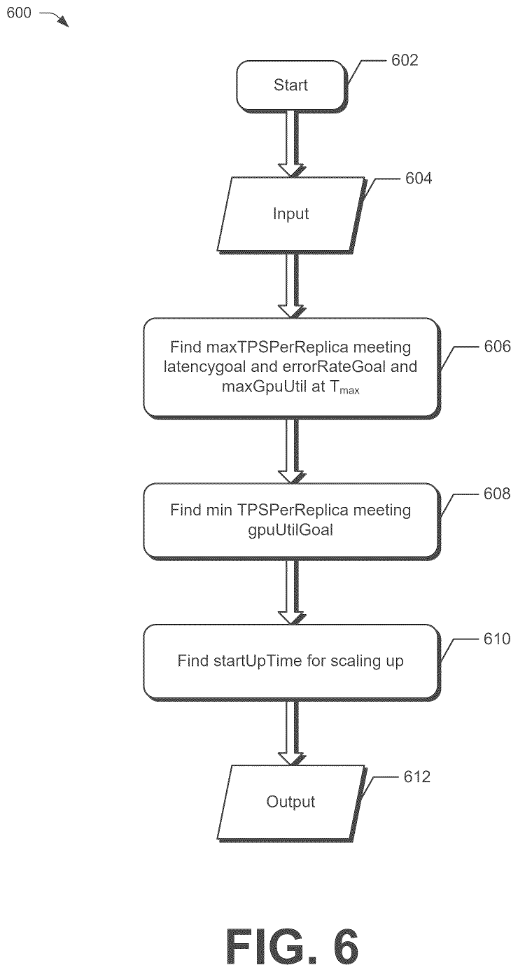

The LnP job corresponds to an LnP test via the LnP testing platform 106. The LnP job may be implemented in the LnP workflow 124 (e.g., an Airflow pipeline). To do so, the model management platform 114 may provide the LnP job to the workflow platform 122 (e.g., Airflow), which may provide implement the LnP job in the LnP workflow 124 over the data plane 104. The controller DAG 126 may be responsible for controlling the entire execution of the automated LnP testing process. For example, as described with reference to FIGS. 6 through 13, the controller DAG 126 may determine a maximum TPS per replica while meeting SLA requirements (i.e., TPSₘₐₓ) and a corresponding maximum GPU utilization (i.e., maxGpuUtil), a minimum TPS per replica while meeting GPU utilization requirements (i.e., TPSₘᵢₙ), and a startup time (i.e., startUpTime) which corresponds to a duration of time between when a scale-up of a replica starts and when the replica is ready to serve traffic. In some example, the controller DAG 126 may submit an LnP API to trigger the LnP DAG 128 instead of triggering the LnP DAG 128 directly.

The LnP DAG 128 (e.g., single round LnP DAG) may operate the LnP testing itself, for example, including obtaining metrics from a GPU model and utilizing binary search algorithms as needed to determine TPSₘₐₓ, maxGpuUtil, TPSₘᵢₙ, and startUpTime, among other metrics. The LnP workflow 124 may provide the metrics and other results of the LnP test to the model management platform 114. The data platform 118 may manage the metrics and corresponding metadata and store the metrics and metadata in a database 120. The database 120 may be a storage device that represents one or more databases and/or other types of storage capable of storing the LnP testing metrics and results, metadata, and/or other data used by the LnP testing platform 106 to perform LnP testing of a GPU model. Examples of the database 120 include, but are not limited to, mass storage and virtual storage. In one or more implementations, for example, the database 120 may be virtualized across a plurality of data centers and/or cloud-based storage devices.

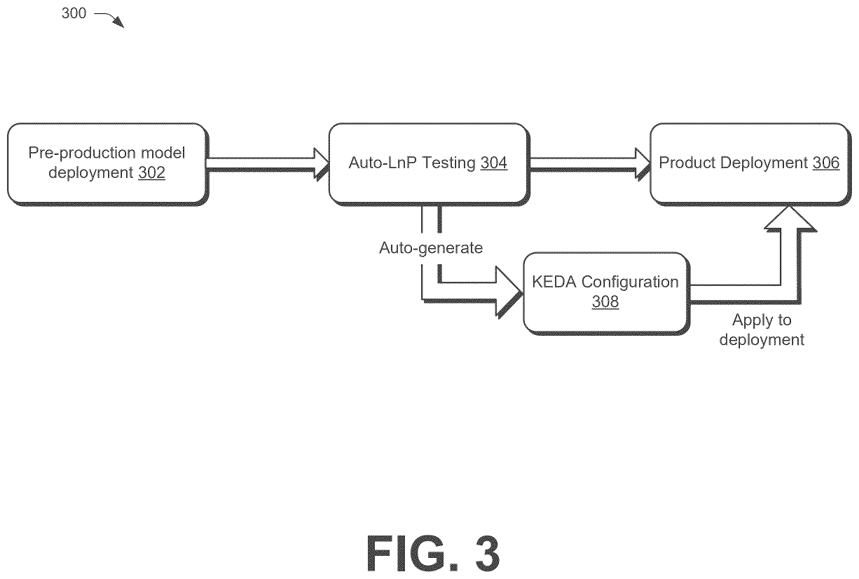

The deployment platform 108 is used to automatically generate an auto-scaling configuration for GPU models. Via the AI hub 112, the users 110 may input an expected TPS (e.g., TPSₘₐₓ and/or TPSₘᵢₙ) and SLA requirements into the deploymentSVC 130. For example, the SLA may include a traffic change slope contract that defines that a traffic change within a time period is not to exceed X percent (e.g., the traffic change within 10 minutes cannot exceed 20%). Based on the inputs and the metrics and results from the LnP testing, the KEDA-enabled federated deployment 132 may generate a KEDA configuration, as described with reference to FIG. 3, and use it to automatically generate an auto-scaling configuration for the GPU model. In some implementations, the auto-scaling configuration may be applied to multiple GPU models.

The workflow platform 122 may enable retries if a task fails. For example, if the LnP workflow 124 fails, the LnP testing process may resume from the failed task. To do so, the steps of the controller DAG 126 may be mapped to tasks in the workflow platform 122, and the workflow platform 122 may configure a given task to be retried three times. Each step in the controller DAG 126 may be stateless, meaning that the controller DAG 126 may read key data from LnP metadata and do nothing if the expected output already exists. Because each step in the controller DAG 126 is stateless, it is safe to retry the steps. If a task fails after all three retries, then the entire LnP workflow 124 may fail. In such cases, the LnP workflow 124 may be resumed manually from the failed task, for example, via a resume application programming interface (API). Alternatively, if the LnP workflow 124 fails completely, the users 110 may manually trigger a new LnP job. The workflow platform 122 may not have a resume API directly, so the state of the failed tasks and their downstream tasks must be cleared, which may be done using a different API of the workflow platform 122. Then, the workflow platform 122 may pick up the cleared tasks and rerun them. In some implementations, if a scale-down of a GPU model fails, an auto-reclaim script may scale down pre-production replicas to zero to limit resource leaks.

Having considered an example of an environment, consider now a discussion of some example details of the techniques for automatically generating auto-scaling configurations for GPUs in accordance with one or more implementations.

### Automated System for Generating Auto-Scaling Configurations for GPUs

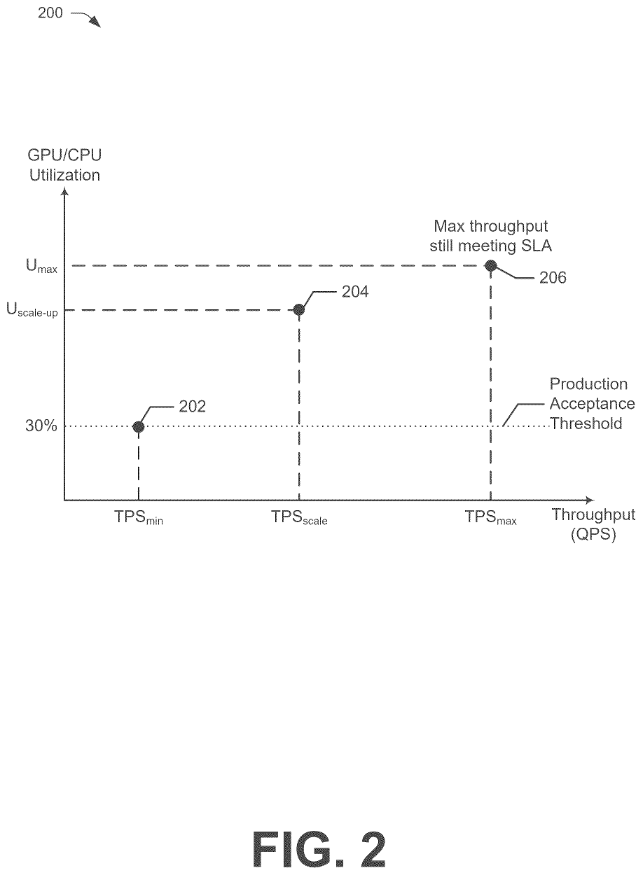

FIG. 2 depicts an example of a scaling threshold diagram 200 for automatically generating auto-scaling configurations for GPUs in accordance with the aspects described herein. The scaling threshold diagram 200 indicates how a scaling threshold 204 is determined from a set of metrics, where the set of metrics are determined based on LnP testing for a GPU model. In some examples, the scaling threshold 204 may be based on a GPU/CPU utilization and a throughput in queries per second (QPS). The GPU/CPU utilization may be measured as a percent utilization (U) and the throughput may be measured by TPS.

As described herein, an auto-scaling configuration may be automatically generated based on LnP testing of GPU models. Because new traffic may suddenly come in, a contract may be defined between a client and server that indicates a speed at which the client may send the traffic to the server such that the server may still be able to handle increased traffic before new GPU pods are ready. This contract may be an SLA. In some implementations, users may provide some value X in the agreement, such as that a traffic change within 10 minutes may not exceed X percent.

The scaling threshold diagram 200 depicts an example in which the client is not to increase over 30% traffic (in terms of GPU/CPU utilization) within 10 minutes (600 seconds). A user may perform LnP testing to determine a maximum TPS (TPSₘₐₓ) that a single GPU model (e.g., a single replica) may handle while still meeting an SLA and a minimum TPS (TPSₘᵢₙ) that the single GPU model may handle while still meeting a platform requirement, for example that GPU/CPU utilization is ≥30%. The point at which the system may have a throughput of TPSₘm with U≥30% may correspond to a threshold 202, which may be a production acceptance threshold. The point at which the system may have a throughput of TPSₘₐₓ with a maximum GPU/CPU utilization (Uₘₐₓ) may correspond to a threshold 206. The threshold 206 may be a maximum throughput while still meeting the SLA.

The system may then perform scaling-up testing to determine an end-to-end start time (TIMEₛₜₐᵣₜ) of a newly onboarded GPU model. Based on the values of TPSₘᵢₘ and TPSₘₐₓ, the system may calculate a scaling threshold 204 of throughput by TPS according

$$max ( {TPS}_{max} * ( 1 - \frac{{TIME}_{s t a r t}}{600} * ( 1 - \frac{1}{1.3} ) , \frac{{TPS}_{min} + {TPS}_{max}}{2} ) ) .$$

The scaling threshold 204 may correspond to a scaling TPS (TPS_{scaie}) and a scaling utilization (U_{scale-up}), which may satisfy the SLA.

Using the scaling threshold diagram 200 to automatically generate auto-scaling configurations may prevent the system from scaling-up GPUs too early, which may result in a low GPU/CPU utilization (e.g., the threshold 202), or too late (e.g., if new traffic comes faster than the system can handle), which may result in the system failing to meet SLA requirements. As such, the techniques described herein may utilize the scaling threshold to automatically determine a correct timing for when to begin scaling up GPU models based on traffic.

FIG. 3 depicts an example of a user flow 300 for automatically generating auto-scaling configurations for GPU models in accordance with the aspects described herein. The user flow 300 may enable a user to perform LnP testing on a newly-deployed GPU model, use KEDA to automatically generate an auto-scaling configuration for the GPU, and deploy the GPU into production with the auto-scaling configuration.

During pre-production model deployment 302, a user at a computing device may onboard a new GPU model, for example, to support traffic on an online marketplace. A system may provide a self-service platform to the user to enable the user to automatically perform LnP testing on the GPU model, and the user may perform the auto-LnP testing 304. In some implementations, the user may trigger the auto-LnP testing 304 with a sample input and a simple button click (e.g., via a user interface).

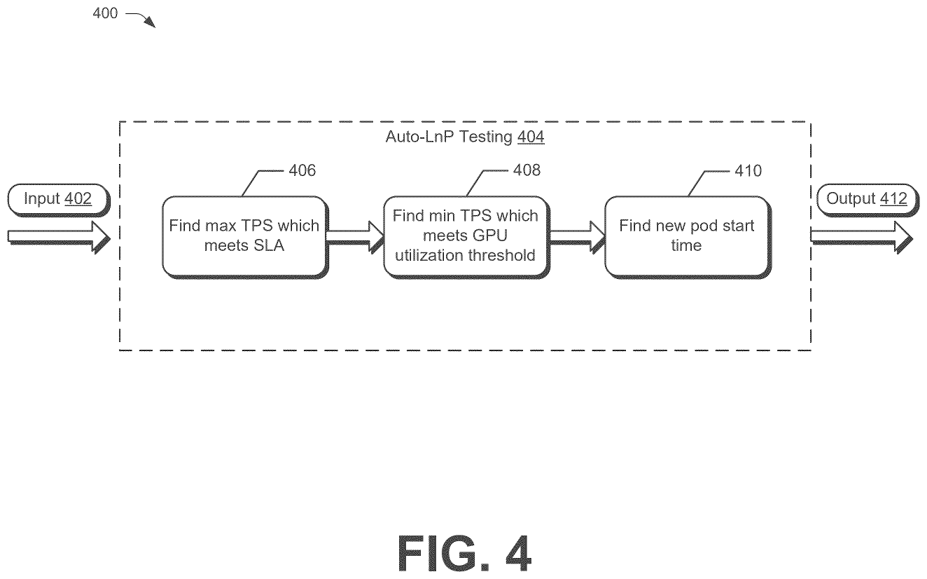

The auto-LnP testing 304 may result in a set of metrics related to the GPU model, such as throughput, utilization, and other metrics. In some implementations, the auto-LnP testing 304 may automatically search for a KEDA configuration 308 that best suits the GPU model. The auto-LnP testing 304 is described with reference to FIG. 4. Using the set of metrics and the KEDA configuration 308, the system may automatically generate an auto-scaling configuration for the GPU model, which may enable efficient scaling of the GPU model based on traffic flows, the set of metrics, and a resource utilization requirement. Referring to the KEDA configuration 308, the system may apply the auto-scaling configuration to the GPU model for deployment and trigger production deployment 306 of the GPU model.

FIG. 4 depicts an example of a test flow 400 for automatically generating auto-scaling configurations for GPU models in accordance with the aspects described herein. The test flow 400 may include auto-LnP testing 404 for a newly deployed GPU model, which may support traffic on an online marketplace. The test flow 400 may be an example of a process for performing auto-LnP testing based on an input to find a best-fit configuration that may be used to automatically generate an auto-scaling configuration for the GPU model.

A user may be provided with a self-service platform for performing the auto-LnP testing 404 for the newly deployed GPU model. The auto-LnP testing 404 may take an input 402, which may include an SLA corresponding to the GPU model (in milliseconds (ms)), a sample payload (e.g., data), and a GPU utilization threshold (e.g., as a percent utilization).

During the auto-LnP testing 404, at 406, the system may find a maximum TPS (TPSₘₐₓ) that still meets the SLA requirements (e.g., latency and error rate requirements). For example, the maximum TPS may correspond to the threshold 206 as described with reference to FIG. 2, which represents a maximum throughput the GPU model may support while still meeting the SLA requirements. At 408, the system may find a minimum TPS (TPSₘᵢₙ) that still meets a GPU utilization threshold. For example, the minimum TPS may correspond to a threshold 202 as described with reference to FIG. 2, which represents a minimum throughput the GPU model may support while still maintaining a production acceptance threshold of 30% GPU/CPU utilization.

The system may use a similar process to find the maximum TPS and the minimum TPS based on a binary search. For example, the system may start with an initial concurrency, concurrency₀, which may represent an ability of the system to support multiple users simultaneously (e.g., during peak traffic times). If the metrics resulting from the LnP testing (e.g., TPSₘₐₓ) meets the SLA requirements, then the system may scale the concurrency to concurrency₁=2*concurrency₀. If the new concurrency fails to meet the SLA requirements, then the system may search back to

$${concurrency}_{2} = \frac{{concurrency}_{0} + {concurrency}_{1}}{2} .$$

The auto-LnP testing 404 may iteratively search the concurrency and converge to an optimal concurrency for the GPU model given the SLA requirements.

Additionally, or alternatively, based on this binary search algorithm, another slope-based binary search may be used to accelerate the convergency. For example, the system may start with an initial concurrency, concurrency₀, and find a latency corresponding to this concurrency, Latencyᵢ. Based on the SLA, the system may calculate a next estimated concurrency as

$${concurrency}_{1} = x = \frac{SLA}{{Latency}_{0}} * {concurrency}_{0} ,$$

where Latency₀ may represent an initial latency.

In some examples, in addition to obtaining the maximum TPS and the minimum TPS per replica, the auto-LnP testing 404 may also result in additional metrics such as a maximum GPU utilization at the maximum TPS (maxGpuUtil). This value may be used for capacity review. Additionally, or alternatively, the results of the auto-LnP testing 404 may ensure that a safe percentage of the maximum TPS (TPS_{safe}) is within a range [Tₘᵢₙ, Tₘₐₓ], where TPS_{safe}=floor(TPSₘₐₓ/(1+X), where a user may define X in an SLA. If TPS_{safe} is outside of the [Tₘᵢₙ, Tₘₐₓ] range, then TPS_{safe} may be unable to meet a GPU utilization goal, and the scaling may be blocked during an intake process, with some possible exceptions. Additionally, or alternatively, the results of the auto-LnP testing 404 may indicate a start-up time in seconds (startupSeconds), which may represent a time it may take for a new GPU model replica to be scaled up and ready to serve traffic. A summary of some metrics output from the auto-LnP testing 404 are shown in Table 1.

TABLE 1
Example metrics resulting from LnP testing

| | Data | Ex- | |
|---|---|---|---|
| Key Result | Type | ample | Description |
| TPSₘₐₓ | Float | 80 | The maximum TPS per replica meeting |
| | | | latency and error rate requirements |
| maxGpuUtil | Float | 0.6 | The maximum GPU utilization at |
| | | | TPSₘₐₓ, which is used for capacity |
| | | | review |
| Tₘᵢₙ | Float | 30 | The minimum TPS per replica meeting |
| | | | a GPU utilization goal (e.g., 30%) |
| startupSeconds | Float | 300 | The time it takes for a new replica to be |
| | | | scaled up and ready to serve traffic |

At 410, the system may find a new pod (e.g., GPU model pod) start time (TIMEₛₜₐᵣₜ), which may correspond to a time at which the GPU model may begin processing data or perform other tasks. As a result of the auto-LnP testing 404, the system may generate an output 412. The output 412 may include the maximum TPS and the minimum TPS (e.g., found using a binary search) and a TPS that may be used for auto-scaling the GPU model (TPS_{scale}). The TPS used for the autoscaling may correspond to a scaling threshold 204 as described with reference to FIG. 2, which represents an optimal throughput (TPS_{scale}) and utilization (U_{scale-up}).

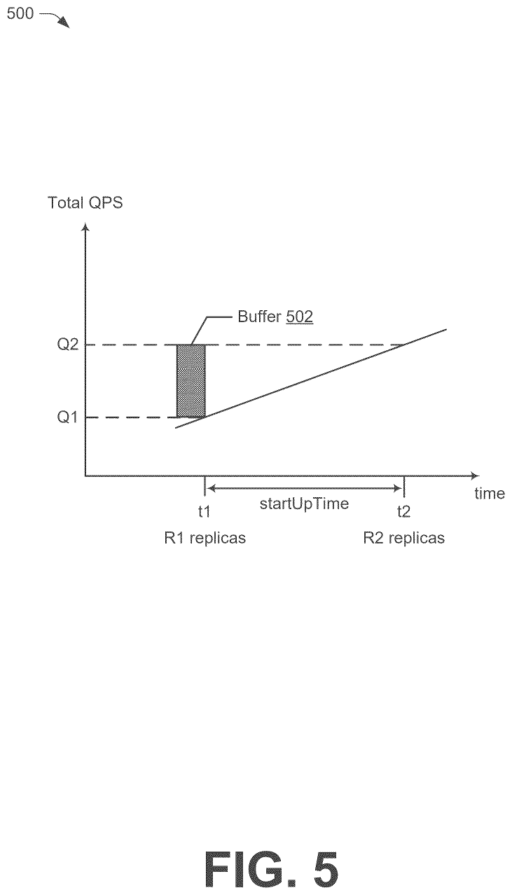

FIG. 5 depicts an example of auto-scaling 500 for automatically generating auto-scaling configurations for GPU models in accordance with the aspects described herein. The auto-scaling 500 may be an example of GPU model auto-scaling as described with reference to FIGS. 2-5. In some examples, the auto-scaling 500 may be based on an auto-scaling configuration that was automatically generated based on LnP testing and a KEDA configuration, as described with reference to FIGS. 3 and 4.

Using a KEDA configuration to automatically generate an auto-scaling configuration for a GPU model may account for how fast GPU models scale up and scale down, how many pods should be scaled up and scaled down, and when each GPU model should be scaled up and scaled down. In some examples, the KEDA configuration may be generated based on metrics resulting from LnP testing (e.g., Tₘₐₓ, Tₘᵢₙ, etc.), a user contract (e.g., SLA), and a user capacity.

The auto-scaling 500 may be based on throughput (QPS) and time. For example, at time t1, a total QPS (e.g., throughput) may be Q1, with R1 replicas (e.g., GPU model replicas) operating. At time t2, the total QPS may increase to Q2, and the number of replicas may scale up to R2 replicas using auto-scaling. The time period between t1 and t2 during which the scaling up occurs may be referred to as startUpTime. In addition, a buffer 502 between Q1 and Q1 may correspond to data or new traffic that needs to be accounted for by auto-scaling the GPU model replicas. That is, the scaling-up may occur in order to support the buffer 502.

Since scaling up (e.g., new pod creation, GPU models downloading and onboarding, and inference engine warmup) takes time, new replicas may not be ready to serve traffic if the traffic increases very rapidly. Accordingly, in some implementations, how fast GPU models scale up may be based on a user contract (e.g., an SLA), which may indicate that changes in traffic are not to exceed a value set out in the contract. For example, non-large language model (LLM) deployments may scale up and be ready within 10 minutes from being onboarded. A contract with users corresponding to this example may indicate that the traffic change within 10 minutes cannot exceed X percent. So, if the contract states that a traffic increase within 10 minutes cannot exceed X %, then during the 10 minutes, the system must scale up X % new replicas. For example, the contract may indicate that a traffic increase within 10 minutes cannot exceed 20%. The contract may specific additional fields, such as a time period in seconds (periodSeconds) that pods may take to become ready for traffic, and a stabilization window period (stabilizationWindowSeconds) during which the system may stabilize after scaling up. For example, the periodSeconds field may be set to a value that allows an auto-scaling system to react to changes in traffic, but not so frequently that the auto-scaling system does not take into account the time a pod may take to become ready for traffic. Since a pod may typically take 3 minutes to start, for example, the periodSeconds field may be set to a value of approximately 60 seconds (1 minute) as a good starting point. This may allow the auto-scaling system to collect metrics at a reasonable frequency without reacting to very short-term fluctuations. The stabilizationWindowSeconds field may be set to a value at least as long as it may take for a new pod to become ready for traffic, if not longer, to prevent the auto-scaling system from initiating additional scaling actions before the new pod has had a chance to impact the observe metrics. For example, given a pod start-up time, the stabilizationWindowSeconds field may be set to a value around 300 seconds (5 minutes) to ensure that the system has time to stabilize after scaling up.

In some implementations, if a replica supports a TPSₘₐₓ per replica, then the system may start scaling up (e.g., scaleUp) the replica at a lower value than TPSₘₐₓ to provide a large enough buffer to maintain SLA requirements. For example, if the traffic increases by 20% in 10 minutes, then the system may start to scale up at a TPS per replica of TPSₘₐₓ/(1+20%) to have the buffer. In some implementations, it may be beneficial to have a relatively more aggressive scale-up policy and a relatively gentler scale-down policy. In such examples, the fields periodSeconds and stabilizationWindowSeconds may have longer values for scaling down (e.g., to scale down by a relatively smaller number). The same triggers that are used for determining when to scale up may be used to determine when to scale down.

In an example of scaling up (e.g., scaleUp) and scaling down (e.g., scaleDown) policies, if TPSₘₐₓ=100, and X=20%, then a TPS-per-replica threshold may be 100/(1+20%)=80. If the current TPS per replica maintains a value of 90 (greater than the threshold) for 5 minutes (a time period equivalent to scaleUp stabilizationWindowSeconds), then the TPS may scale up. With 6 current replicas, the system may scale up to max(1, ceil(6*20%))=2 pods. After triggering the scaleUp, the system may enable a cooldown time of 5 minutes (scaleUp stabilizationWindowSeconds) before considering a subsequent scaleUp. This may prevent flipping replicas as pod start-up takes time. If the current TPS per replica maintains a value of 70 (less than the threshold) for 15 minutes (scaleUp stabilizationWindowSeconds), then the system may scale down by 1 pod. After triggering the scaleDown, the system may allow a cooldown time of 15 minutes (scaleUp stabilizationWindowSeconds) before considering the next scaleDown. In the examples described herein, the deployment service may integrate a KEDA configuration in the spec and create a federated deployment with KEDA enabled.

FIG. 6 depicts an example of a process flow 600 for automatically generating auto-scaling configurations for GPU models in accordance with the aspects described herein. Specifically, the process flow 600 may depict an example of LnP testing, as described herein with reference to FIG. 4.

At 602, the automated LnP process may start for a GPU model. At 604, a set of metrics may be input into the LnP testing platform. For example, the input may include values for metrics including at least one of a project type or name (i.e., project), infSVC, a library (i.e., mlapp), a latency goal (i.e., latencyGoal), an error rate goal (i.e., errorRateGoal), a GPU utilization goal (i.e., gpuUtilGoal), a payload, a warmup time (i.e., warmUpSeconds), a duration time (i.e., durationSeconds), and an LnP pattern (i.e., lnpPattern), among other input metrics. The input at 604 may correspond to the input 402 as described with reference to FIG. 4.

At 606, using LnP testing, the system may find a maximum TPS per replica (i.e., maxTPSPerReplica, TPSₘₐₓ) that meets the latency goal (i.e., latencygoal), the error rate goal (i.e., errorRateGoal), and the maximum GPU utilization at TPSₘₐₓ (i.e., maxGpuUtil). The latency goal, the error rate goal, and the max GPU utilization may be defined in an SLA with the user.

At 608, using the LnP testing, the system may find a minimum TPS per replica (i.e., minTPSPerReplica, TPSₘᵢₙ) that meats the GPU utilization goal (i.e., gpuUtilGoal). The GPU utilization goal may be defined in the SLA with the user.

At 610, using the LnP testing, the system may find a start-up time (i.e., startUpTime) for scaling up the replicas. The start-up time may represent a time it may take for a replica to scale up and be ready to serve traffic.

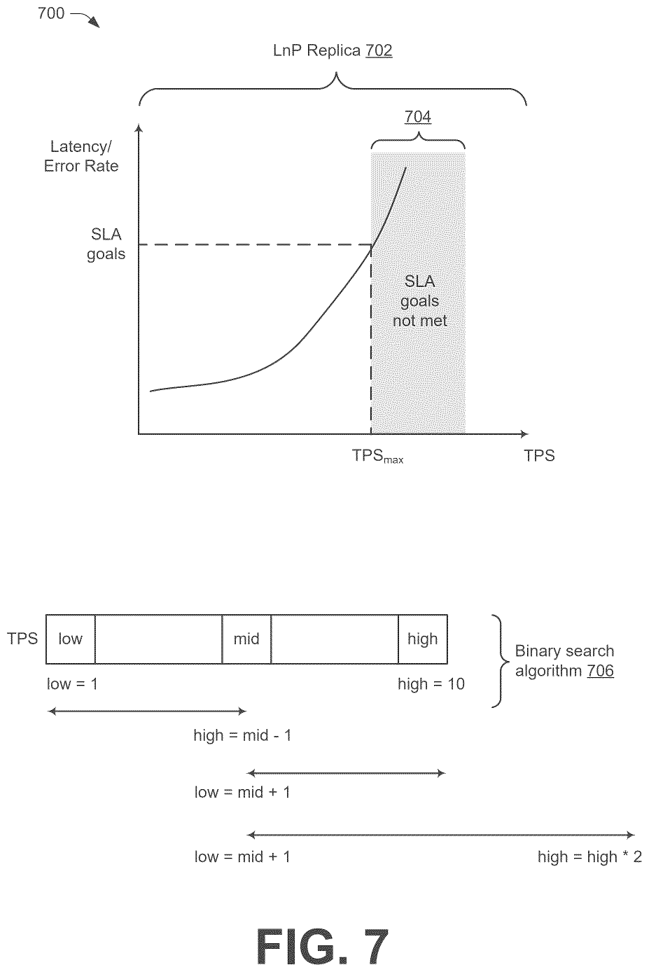

At 612, the system may output the results of the LnP testing. In some implementations, the output may include the TPSₘₐₓ, the TPSₘᵢₙ, the maxGpuUtil, and the startUpTime. Additional details about TPSₘₐₓ and maxGpuUtil are described herein with reference to FIG. 7.

FIG. 7 depicts an example of a binary search 700 for automatically generating auto-scaling configurations for GPU models in accordance with the aspects described herein. The binary search 700 may show an example of how to determine values for a maximum TPS per replica (i.e., TPSₘₐₓ) and a maximum GPU utilization (i.e., maxGpuUtil) for auto-scaling a GPU model.

In the example of FIG. 7, for an LnP replica 702, latency/error rate may increase with throughout (e.g., TPS). When TPS is larger than a particular value, SLA goals, such as latency and error rate goals, may not be met. For the LnP replica 702, for example, SLA goals may not be met in a region 704, which corresponds to a TPS greater than TPSₘₐₓ and a latency/error rate greater than the latency and error goals included in the SLA goals. As such, as described herein, a system may use LnP testing to find a maximum TPS per replica that meets the SLA goals (i.e., TPSₘₐₓ) and a GPU utilization at the maximum TPS per replica (i.e., maxGpuUtil).

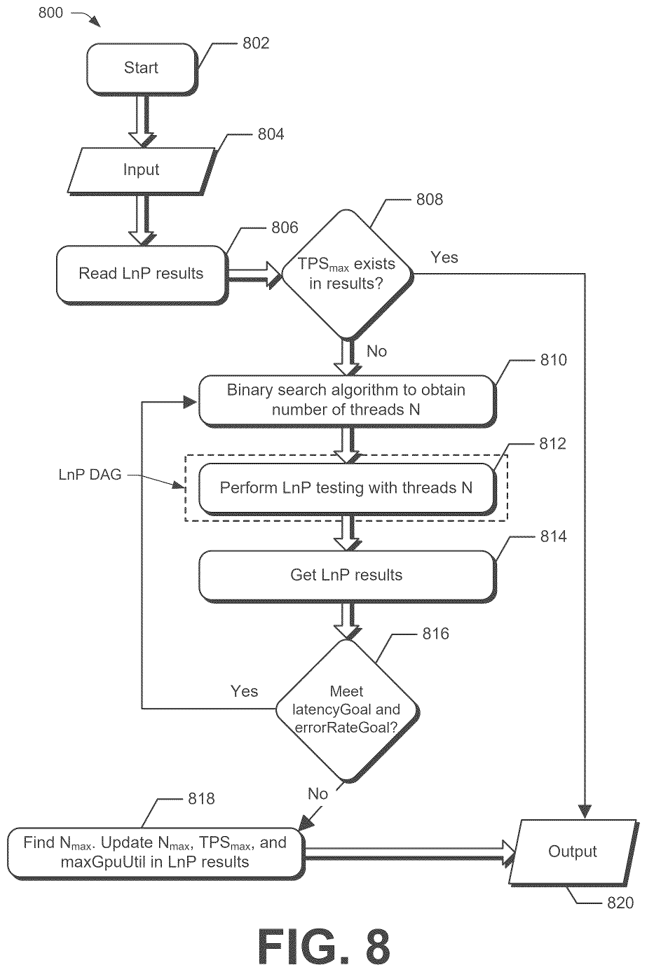

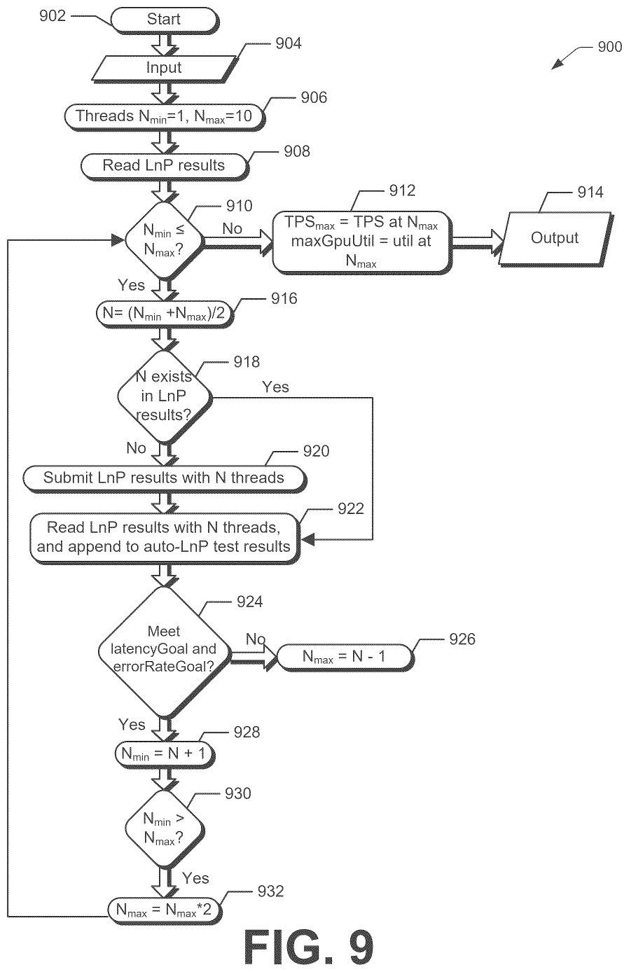

To find TPSₘₐₓ and maxGpuUtil, the system may utilize a binary search algorithm 706. In the example of the binary search algorithm 706, TPS may be evaluated on a scale of low (e.g., low=1 TPS), mid, and high (e.g., high=10 TPS). If the mid TPS value does not meet the SLA goal (where high=mid=1), then low=mid+1. If the low value is greater than the high value, such that even the high value meets the SLA goals, then low=mid+1 and high=high*2. In such cases, TPSₘₐₓ=high=high*2. Additional details regarding how TPSₘₐₓ and maxGpuUtil are determined are described with reference to FIGS. 8 and 9.

FIG. 8 depicts an example of a process flow 800 for automatically generating auto-scaling configurations for GPU models in accordance with the aspects described herein. Specifically, the process flow 800 depicts an example of determining a maximum TPS per replica (TPSₘₐₓ) and a maximum GPU utilization (maxGpuUtil) based on LnP testing for a GPU model.

At 802, an automated LnP process may start for a GPU model. At 804, a set of metrics may be input into an LnP testing platform. The input may include values for at least one of a latency goal (i.e., latencyGoal), an error rate goal (i.e., errorRateGoal), a payload, a warmup time (i.e., warmUpSeconds), a duration time (i.e., durationSeconds), and an LnP pattern (i.e., lnpPattern), among other input metrics. The input at 804 may correspond to the input 402 as described with reference to FIG. 4.

At 806, the system may read results from the LnP testing, which may include values for a set of metrics corresponding to a GPU model. At 808, the system may determine if a value for TPSₘₐₓ exists in the results of the LnP testing.

At 810, if the results lack a value for TPSₘₐₓ, then the system may use a binary search algorithm to obtain a number of threads, N. For example, the system may use a binary search algorithm, as described with reference to FIG. 7, to determine values for, TPSₘₐₓ and maxGpuUtil.

At 812, the system may perform one round of LnP testing with the threads N based on the binary search. In some examples, the LnP testing may correspond to an LnP DAG. At 814, the system may obtain results from the LnP testing, which may include values for the set of metrics corresponding to the GPU model. In this example, the results may include TPSₘₐₓ.

At 816, the system may determine whether the results of the LnP testing meet SLA requirements, including a latency goal (i.e., latencyGoal) and an error rate goal (i.e., errorRateGoal).

At 818, if the results fail to meet the latency goal and the error rate goal, then the system may identify Nₘₐₓ (e.g., a maximum number of threads), and update Nₘₐₓ, TPSₘₐₓ, and maxGpuUtil in the LnP results. At 820, the system may output the results of the LnP testing. The results may include TPSₘₐₓ and maxGpuUtil. Alternatively, if the results meet the latency goal and the error rate goal, then the system may repeat the process beginning at 810, using the binary search algorithm to obtain a number of threads, N, and perform iterative LnP testing until an optimal value for TPSₘₐₓ is determined.

Alternatively, at 808, the initial LnP results may include TPSₘₐₓ. In such cases, at 820, the system may automatically output the results of the LnP testing, including TPSₘₐₓ and maxGpuUtil.

FIG. 9 depicts an example of a process flow 900 for automatically generating auto-scaling configurations for GPU models in accordance with the aspects described herein. Specifically, the process flow 900 depicts an example of determining a maximum TPS per replica (TPSₘₐₓ) and a maximum GPU utilization (maxGpuUtil) based on LnP testing for a GPU model.

At 902, an automated LnP process may start for a GPU model. At 904, a set of metrics may be input into an LnP testing platform. The input may include values for at least one of a latency goal (i.e., latencyGoal), an error rate goal (i.e., errorRateGoal), a payload, a warmup time (i.e., warmUpSeconds), a duration time (i.e., durationSeconds), and an LnP pattern (i.e., lnpPattern), among other input metrics. The input at 904 may correspond to the input 402 as described with reference to FIG. 4.

At 906, the system may use a binary search algorithm with threads Nₘᵢₙ=1 and Nₘₐₓ=10. For example, the system may use a binary search algorithm, as described with reference to FIG. 7, to determine values for a maximum TPS per replica (i.e., TPSₘₐₓ) and a maximum GPU utilization (i.e., maxGpuUtil). The system may use the binary search algorithm as a part of LnP testing for a GPU model.

At 908, the system may read results from the LnP testing, which may include values for a set of metrics corresponding to the GPU model. At 910, based on the results of the LnP testing, the system may determine whether Nₘᵢₙ, is less than Nₘₐₓ. At 912, if Nₘᵢₙ is greater than Nₘₐₓ, then the system may determine that the TPSₘₐₓ=TPS at Nₘₐₓ, and that maxGpuUtil=utilization at Nₘₐₓ. At 914, the system may output the results of the LnP testing, including TPSₘₐₓ and maxGpuUtil.

Alternatively, at 916, if Nₘᵢₙ is less than Nₘₐₓ, then the system may go on to calculate a number of threads N as N=(Nₘᵢₙ+Nₘₐₓ)/2. At 918, the system may determine whether N exists in the LnP results. At 920, if the LnP results lack a value for N, then the system may submit one round of LnP results with N threads. At 922, the system may read the LnP results with N threads and append these results to results of an auto-LnP testing. Alternatively, if it is determined at 918 that N does exist in the LnP results, then the system may automatically read the LnP results with the N threads and append these results to the results of the auto-LnP testing.

At 924, the system may determine whether the results from the LnP testing with N threads and the auto-LnP testing meet latency goal (i.e., latencyGoal) and error rate goal (i.e., errorRateGoal) requirements, which may correspond to SLA requirements.

At 926, if the results fail to meet the latency goal and error rate goal requirements, then the system may calculate Nₘₐₓ=N−1. Alternatively, at 928, if the results meet the latency goal and error rate goal requirements, then the system may calculate Nₘᵢₙ=N+1. At 930, the system may determine whether Nₘᵢₙ is greater than Nₘₐₓ. At 932, if Nₘᵢₙ is greater than Nₘₐₓ, then Nₘₐₓ=Nₘₐₓ*2. At this point, the system may return to 910 and repeat 910 through 932 iteratively until a desired TPSₘₐₓ and maxGpuUtil are output at 914.

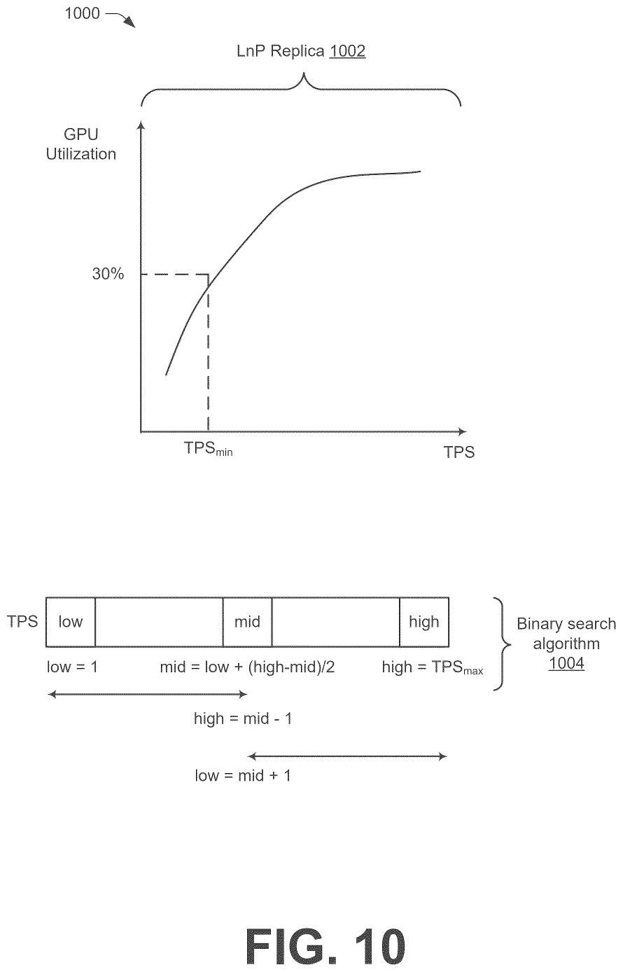

FIG. 10 depicts an example of a binary search 1000 for automatically generating auto-scaling configurations for GPU models in accordance with the aspects described herein. The binary search 1000 may show an example of how to determine values for a minimum TPS per replica (i.e., TPSₘᵢₙ) for auto-scaling a GPU model.

In the example of FIG. 10, for an LnP replica 1002, GPU utilization may increase with throughput (e.g., TPS). For the LnP replica 1002, for example, TPSₘᵢₙ may correspond to a 30% GPU utilization, which may be a minimum requirement (e.g., as set out in an SLA). As such, as described herein, a system may use LnP testing to find a minimum TPS per replica that meets the GPU utilization goal of 30% (i.e., TPSₘᵢₙ).

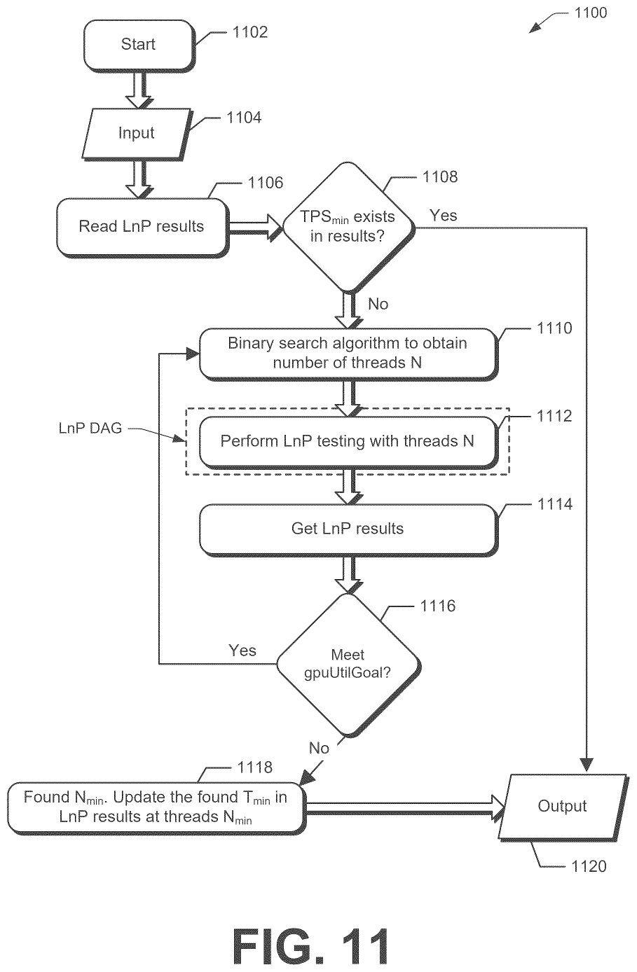

To find TPSₘᵢₙ, the system may utilize a binary search algorithm 1004. In the example of the binary search algorithm 1004, TPS may be evaluated on a scale of low (e.g., low=1 TPS), mid (i.e., mid=low+(high−mid)/2), and high (e.g., high=Tₘₐₓ). If the mid TPS meets the GPU utilization goal, then high=mid−1. Otherwise, if the mid TPS fails to meet the GPU utilization goal, then low=mid+1. In such cases, if low>high, then Tₘᵢₙ=low. Additional details regarding how Tₘᵢₙ is determined are described with reference to FIGS. 11-13.

FIG. 11 depicts an example of a process flow 1100 for automatically generating auto-scaling configurations for GPU models in accordance with the aspects described herein. Specifically, the process flow 1100 depicts an example of determining a minimum TPS per replica (TPSₘᵢₙ) based on LnP testing for a GPU model.

At 1102, an automated LnP process may start for a GPU model. At 1104, a set of metrics may be input into an LnP testing platform. The input may include values for at least one of a GPU utilization goal (i.e., gpuUtilGoal, a payload, a warmup time (i.e., warmUpSeconds), a duration time (i.e., durationSeconds), and an LnP pattern (i.e., lnpPattern), among other input metrics. The input at 1102 may correspond to the input 402 as described with reference to FIG. 4.

At 1106, the system may read results from the LnP testing, which may include values for a set of metrics corresponding to a GPU model. At 1108, the system may determine if a value for TPSₘᵢₙ exists in the results of the LnP testing.

At 1110, if the results lack a value for TPSₘᵢₙ, then the system may use a binary search algorithm to obtain a number of threads, N. For example, the system may use a binary search algorithm, as described with reference to FIG. 7, to determine a value for TPSₘᵢₙ.

At 1112, the system may perform one round of LnP testing with the threads N based on the binary search. In some examples, the LnP testing may correspond to an LnP DAG. At 1114, the system may obtain results from the LnP testing, which may include values for the set of metrics corresponding to the GPU model. In this example, the results may include TPSₘᵢₙ.

At 1116, the system may determine whether the results of the LnP testing meet system requirements, including GPU utilization goal (i.e., gpuUtilGoal).

At 1118, if the results fail to meet the GPU utilization goal, then the system may identify Nₘᵢₙ (e.g., a minimum number of threads), and update TPSₘᵢₙ which was a result of the LnP test for Nₘᵢₙ threads. At 1120, the system may output the results of the LnP testing, which may include TPSₘᵢₙ. Alternatively, if the results meet the GPU utilization goal, then the system may repeat the processes beginning at 1110, using the binary search algorithm to obtain a number of threads, N, and perform iterative LnP testing until an optimal value for TPSₘᵢₙ is determined.

Alternatively, at 1108, the initial LnP results may include TPSₘᵢₙ. In such cases, at 1120, the system may automatically output the results of the LnP testing, including TPSₘᵢₙ.

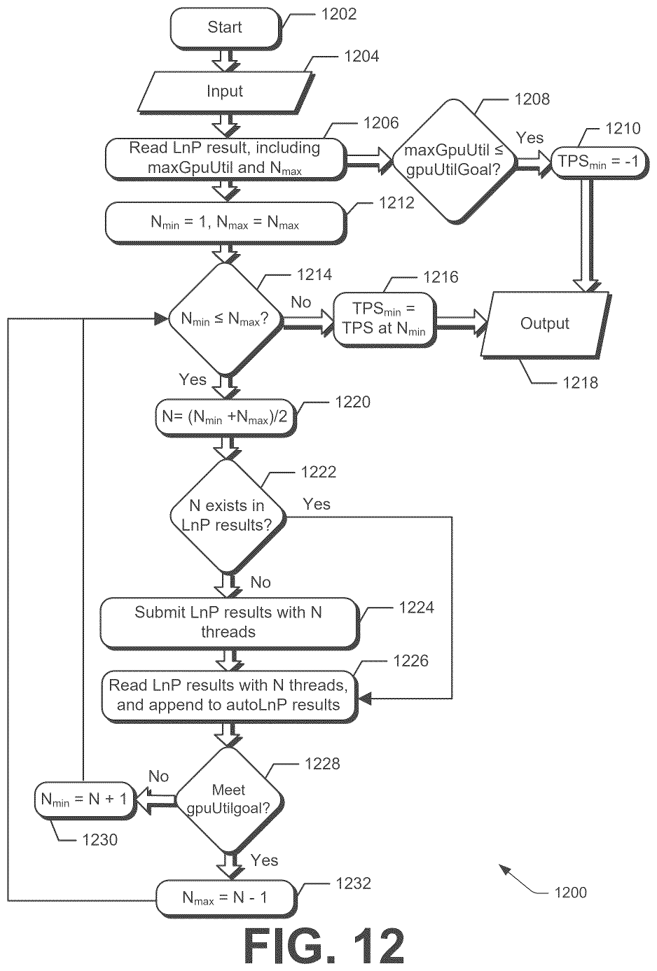

FIG. 12 depicts an example of a process flow 1200 for automatically generating auto-scaling configurations for GPU models in accordance with the aspects described herein. Specifically, the process flow 1200 depicts an example of determining a minimum TPS per replica (TPSₘᵢₙ) based on LnP testing for a GPU model.

At 1202, an automated LnP process may start for a GPU model. At 1204, a set of metrics may be input into an LnP testing platform. The input may include values for at least a GPU utilization goal (i.e., gpuUtilGoal), among other input metrics. The GPU utilization goal may be a system requirement that a certain percentage of GPU resources are utilized (e.g., 30%). The input at 1204 may correspond to the input 402 as described with reference to FIG. 4.

At 1206, the system may read results from the LnP testing, which may include values for a set of metrics corresponding to the GPU model. For example, the results may include a maximum number of threads for a binary search algorithm (i.e., Nₘₐₓ) and a maximum GPU utilization (i.e., maxGpuUtil).

In some implementations, at 1208, the system may determine whether the maximum GPU utilization is less than the GPU utilization goal. At 1210, if the maximum GPU utilization is less than the GPU utilization goal, then the system may determine that the TPSₘᵢₙ=−1. At 1218, based on determining that TPSₘᵢₙ=−1 when the maximum GPU utilization is less than the GPU utilization goal, the system may output the results of the LnP testing, including TPSₘᵢₙ=−1.

Alternatively at 1212, based on reading the LnP results including the maximum GPU utilization and Nₘₐₓ, the system may determine that Nₘᵢₙ=1 and Nₘₐₓ=Nₘₐₓ for a binary search algorithm. In some implementations, the system may use a binary search algorithm, as described with reference to FIG. 7, to determine TPSₘᵢₙ. The system may use the binary search algorithm as a part of LnP testing for the GPU model.

At 1214, the system may determine whether Nₘᵢₙ is less than or equal to Nₘₐₓ. At 1216, if Nₘᵢₙ is greater than Nₘₐₓ, then the system may determine that the TPSₘᵢₙ=TPS at Nₘᵢₙ. That is, TPSₘᵢₙ may be determined from the binary search algorithm with a number of threads Nₘᵢₙ. In such cases, at 1218, the system may output the results of the LnP testing, including TPSₘᵢₙ.

Alternatively, at 1220, if Nₘᵢₙ is less than or equal to Nₘₐₓ, then the system may go on to calculate a number of threads N for the binary search algorithm as N=(Nₘᵢₙ+Nₘₐₓ)/2. At 1222, the system may determine whether N exists in the LnP results. At 1224, if the LnP results lack a value for N, then the system may submit one round of LnP results with N threads. At 1226, the system may read the LnP results with N threads and append these results to results of an auto-LnP testing.

Alternatively, if it is determined at 1222 that N does exist in the LnP results, then the system may automatically read the LnP results with the N threads and append these results to the results of the auto-LnP testing.

At 1228, the system may determine whether the results from the LnP testing with N threads and the auto-LnP testing meet the GPU utilization goal.

At 1230, if the results fail to meet the GPU utilization goal, then the system may calculate Nₘᵢₙ=N+1. In such cases, the system may return to 1214, and repeat 1214 through 1218 or 1214 through 1230 until Nₘᵢₙ is less than or equal to Nₘₐₓ in order to determine TPSₘᵢₙ.

Alternatively, at 1232, if the results meet the GPU utilization goal, then the system may calculate Nₘₐₓ=N−1. Similarly, in such cases, the system may return to 1214, and repeat 1214 through 1218 or 1214 through 1230 until Nₘᵢₙ is less than or equal to Nₘₐₓ in order to determine TPSₘᵢₙ.

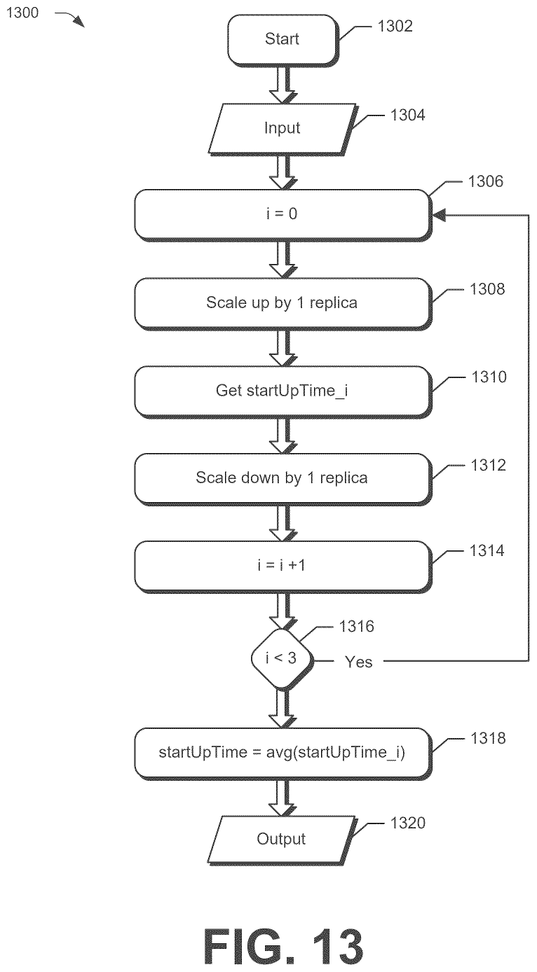

FIG. 13 depicts an example of a process flow 1300 for automatically generating auto-scaling configurations for GPU models in accordance with the aspects described herein. Specifically, the process flow 1300 depicts an example of determining a startup time (i.e., startUpTime) based on LnP testing for a GPU model. The startup time may be a duration of time between when a GPU model or replica begins scaling up and when the GPU model may be ready to serve traffic. In the process flow 1300, the startup time is measured three times, and an average startup time is calculated.

At 1302, an automated LnP process may start for a GPU model. At 1304, a set of metrics may be input into an LnP testing platform. For example, the input may include values for at least one of a project type or name (i.e., project), infSVC, a library (i.e., mlapp). The input at 1304 may correspond to the input 402 as described with reference to FIG. 4.

At 1306, the system may determine that i=0, where i may represent a GPU model or replica that is being scaled up. At 1308, the system may scale up by one replica, for example, based on detecting an increase in traffic.

At 1310, after scaling up by one replica, the system may obtain a startup time corresponding to the replica, i (i.e., startUpTime_i). The startup time may represent the time that the replica started to scale up.

At 1312, the system may scale down by one replica, for example, based on detecting a decrease in traffic. At 1314, based on the scaling down, i=i+1, which indicates a second replica to be scaled up.

At 1316, the system may determine whether i is less than 3. If i is less than 3, then the system may return to 1306, setting i=0, and repeat 1308 through 1316 until i is at least 3. The goal of the system is to measure the startup time 3 times such that an average startup time may be calculated.

At 1318, if i is at least 3, then the system may calculate an average startup time, as startUpTime=avg(startUpTime_i). In this way, the system may calculate a more accurate startup time corresponding to a replica, such that appropriate time may be allowed before the replica begins serving traffic. At 1320, the system may output the average startup time.

Having discussed exemplary details of an AI-based smart actioning system, consider now some examples of procedures to illustrate additional aspects of the techniques.

### Example Procedures

This section describes examples of procedures for an system for automatically generating auto-scaling configurations for GPU models. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

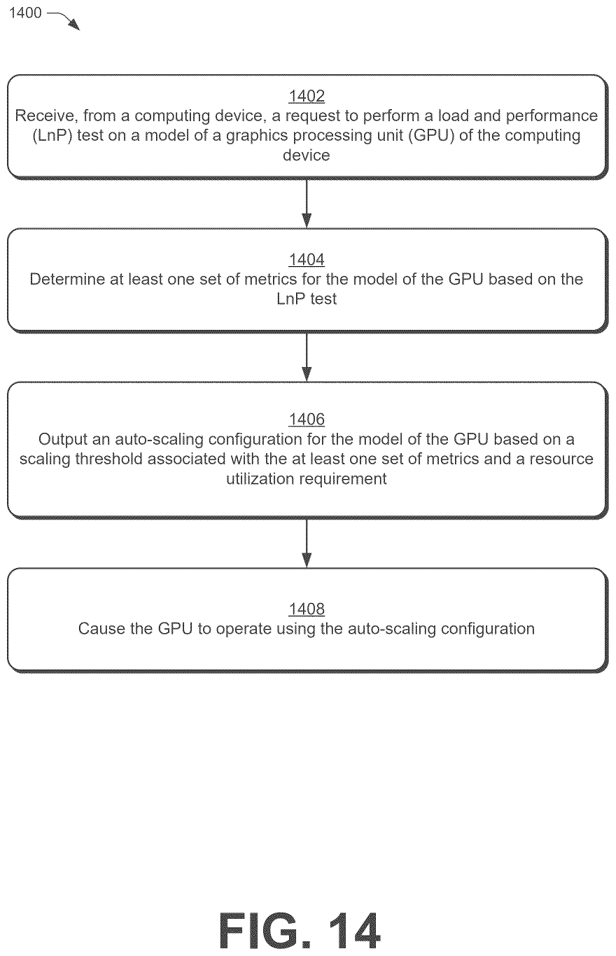

FIG. 14 depicts a procedure 1400 in an example implementation of a system for automatically generating auto-scaling configurations for GPU models.

A request to perform an LnP test on a model of a GPU of the computing device may be received from a computing device (block 1402). By way of example, the users 110 may submit an LnP job to the model management platform 114, the LnP job for performing the LnP test on the GPU model.

At least one set of metrics for the model of the GPU may be determined based on the LnP test (block 1404). By way of example, the model management platform 114 may provide the LnP job to the workflow platform 122, which may facilitate the LnP testing via the LnP workflow 124. The set of metrics may include a maximum TPS per replica while meeting SLA requirements (i.e., TPSₘₐₓ) and a minimum TPS per replica while meeting a GPU utilization goal (i.e., TPSₘᵢₙ), among other metrics.

An auto-scaling configuration for the model of the GPU may be output based on a scaling threshold associated with the at least one set of metrics and a resource utilization requirement (block 1406). By way of example, a deployment platform 108 may generate a KEDA configuration and use the KEDA configuration to automatically generate an auto-scaling configuration for the GPU model.

A GPU may be caused to operate using the auto-scaling configuration (block 1408). By way of example, the deployment platform 108 may deploy the GPU into production (e.g., to facilitate traffic of an online marketplace) using KEDA-enabled federated deployment 132. In some example, the auto-scaling configuration may cause the GPU to scale up or scale down based on changes in traffic.

Having described examples of procedures in accordance with one or more implementations, consider now an example of a system and device that can be utilized to implement the various techniques described herein.

### Example System and Device

FIG. 15 illustrates an example of a system 1500 generally that includes an example of a computing device 1502 that is representative of one or more computing systems and/or devices that may implement the various techniques described herein. The computing device 1502 may be, for example, a server of a service provider, a device associated with a client (e.g., a client device), an on-chip system, and/or any other suitable computing device or computing system.

The example computing device 1502 as illustrated includes a processing system 1504, one or more computer-readable media 1506, and one or more I/O interfaces 1508 that are communicatively coupled, one to another. Although not shown, the computing device 1502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1504 is representative of functionality to perform one or more operations using hardware. Accordingly, the processing system 1504 is illustrated as including hardware elements 1510 that may be configured as processors, functional blocks, and so forth. This may include implementation in hardware as an application specific integrated circuit or other logic device formed using one or more semiconductors. The hardware elements 1510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1506 is illustrated as including memory/storage 1512. The memory/storage 1512 represents memory/storage capacity associated with one or more computer-readable media. The memory/storage 1512 may include volatile media (such as random access memory (RAM)) and/or nonvolatile media (such as read only memory (ROM), Flash memory, optical disks, magnetic disks, and so forth). The memory/storage 1512 may include fixed media (e.g., RAM, ROM, a fixed hard drive, and so on) as well as removable media (e.g., Flash memory, a removable hard drive, an optical disc, and so forth). The computer-readable media 1506 may be configured in a variety of other ways as further described below.

Input/output interface(s) 1508 are representative of functionality to allow a user to enter commands and information to computing device 1502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1502 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1502. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1510 and computer-readable media 1506 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1510. The computing device 1502 may be configured to implement particular instructions and/or functions corresponding to the software and/or hardware modules. Accordingly, implementation of a module that is executable by the computing device 1502 as software may be achieved at least partially in hardware, e.g., through use of computer-readable storage media and/or hardware elements 1510 of the processing system 1504. The instructions and/or functions may be executable/operable by one or more articles of manufacture (for example, one or more computing devices 1502 and/or processing systems 1504) to implement techniques, modules, and examples described herein.

The techniques described herein may be supported by various configurations of the computing device 1502 and are not limited to the specific examples of the techniques described herein. This functionality may also be implemented all or in part through use of a distributed system, such as over a “cloud” 1514 via a platform 1516 as described below.

The cloud 1514 includes and/or is representative of a platform 1516 for resources 1518. The platform 1516 abstracts underlying functionality of hardware (e.g., servers) and software resources of the cloud 1514. The resources 1518 may include applications and/or data that can be utilized while computer processing is executed on servers that are remote from the computing device 1502. Resources 1518 can also include services provided over the Internet and/or through a subscriber network, such as a cellular or Wi-Fi network.

The platform 1516 may abstract resources and functions to connect the computing device 1502 with other computing devices. The platform 1516 may also serve to abstract scaling of resources to provide a corresponding level of scale to encountered demand for the resources 1518 that are implemented via the platform 1516. Accordingly, in an interconnected device embodiment, implementation of functionality described herein may be distributed throughout the system 1500. For example, the functionality may be implemented in part on the computing device 1502 as well as via the platform 1516 that abstracts the functionality of the cloud 1514.

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
receiving, from a computing device, a request to perform a load and performance (LnP) test on a model of a graphics processing unit (GPU) of the computing device;
determining at least one set of metrics for the model of the GPU based on the LnP test;
outputting an auto-scaling configuration for the model of the GPU based on a scaling threshold associated with the at least one set of metrics and a resource utilization requirement; and
causing the GPU to operate using the auto-scaling configuration.

2. The computer-implemented method of claim 1, further comprising:
receiving an additional request to perform the LnP test of the model of the GPU;
performing the LnP test based on the additional request; and
outputting an updated auto-scaling configuration based on at least one additional set of metrics determined for the model of the GPU based on the LnP test.

3. The computer-implemented method of claim 1, further comprising:
receiving, from an additional computing device, an additional request to perform the LnP test for a plurality of models of GPUs;
outputting a plurality of auto-scaling configurations based on at least one additional set of metrics determined for the plurality of models of GPUs based on the LnP test;
storing the plurality of auto-scaling configurations; and
causing the GPUs to operate using the plurality of auto-scaling configurations.

4. The computer-implemented method of claim 1, further comprising applying the auto-scaling configuration to a plurality of models of GPUs.

5. The computer-implemented method of claim 1, wherein outputting the auto-scaling configuration comprises:
determining the scaling threshold based on the at least one set of metrics, including a maximum transaction per second (TPS) and a minimum TPS, and wherein the maximum TPS and the minimum TPS are based on a service level agreement (SLA) corresponding to the model of the GPU.

6. The computer-implemented method of claim 1, wherein the LnP test is based on at least one of a service level agreement (SLA), a sample payload, and a GPU utilization threshold.

7. The computer-implemented method of claim 1, wherein determining the at least one set of metrics comprises determining a maximum TPS and a maximum GPU utilization corresponding to the maximum TPS based on a binary search, wherein the binary search is based on a latency goal and an error rate goal.

8. The computer-implemented method of claim 1, wherein determining the at least one set of metrics comprises determining a startup time associated with the model of the GPU, wherein the startup time is a duration of time between when a scaling up of the model of the GPU begins and when the model of the GPU is ready to serve traffic.

9. The computer-implemented method of claim 1, wherein the auto-scaling configuration includes at least one of a time at which the model of the GPU is to begin scaling up or a time at which the model of the GPU is to begin scaling down based on a maximum TPS and an SLA.

10. The computer-implemented method of claim 1, wherein the auto-scaling configuration is associated with Kubernetes event-driven auto-scaling (KEDA).

11. The computer-implemented method of claim 1, wherein the auto-scaling configuration enables scaling of a quantity of GPUs used for the computing device based on the at least one set of metrics and the resource utilization requirement.

12. A system comprising:
one or more processors; and
memory storing instructions that, when executed by the one or more processors,
cause the system to:
receive, from a computing device, a request to perform a load and performance (LnP) test on a model of a graphics processing unit (GPU) of the computing device;
determine at least one set of metrics for the model of the GPU based on the LnP test;
output an auto-scaling configuration for the model of the GPU based on a scaling threshold associated with the at least one set of metrics and a resource utilization requirement; and
cause the GPU to operate using the auto-scaling configuration.

13. The system of claim 12, wherein the instructions further cause the system to:
receive an additional request to perform the LnP test of the model of the GPU;
perform the LnP test based on the additional request; and
output an updated auto-scaling configuration based on at least one additional set of metrics determined for the model of the GPU based on the LnP test.

14. The system of claim 12, wherein the instructions further cause the system to:
receive, from an additional computing device, an additional request to perform the LnP test for a plurality of models of GPUs;
output a plurality of auto-scaling configurations based on at least one additional set of metrics determined for the plurality of models of GPUs based on the LnP test;
store the plurality of auto-scaling configurations; and
cause the GPUs to operate using the plurality of auto-scaling configurations.

15. The system of claim 12, wherein the instructions further cause the system to apply the auto-scaling configuration to a plurality of models of GPUs.

16. The system of claim 12, wherein, to output the auto-scaling configuration, the instructions further cause the system to determine the scaling threshold based on the at least one set of metrics, including a maximum transaction per second (TPS) and a minimum TPS, and wherein the maximum TPS and the minimum TPS are based on a service level agreement (SLA) corresponding to the model of the GPU.

17. The system of claim 12, wherein the LnP test is based on at least one of a service level agreement (SLA), a sample payload, and a GPU utilization threshold.

18. The system of claim 12, wherein the auto-scaling configuration is associated with Kubernetes event-driven auto-scaling (KEDA).

19. The system of claim 12, wherein the auto-scaling configuration enables scaling of a quantity of GPUs used for the computing device based on the at least one set of metrics and the resource utilization requirement.

20. A non-transitory computer-readable media storing instructions that, when executed by one or more processors, cause the one or more processors to perform operations including:
receiving, from a computing device, a request to perform a load and performance (LnP) test on a model of a graphics processing unit (GPU) of the computing device;
determining at least one set of metrics for the model of the GPU based on the LnP test;
outputting an auto-scaling configuration for the model of the GPU based on a scaling threshold associated with the at least one set of metrics and a resource utilization requirement; and
causing the GPU to operate using the auto-scaling configuration.
